(19) United States
(12) Patent Application Publication
(10) Pub. No.: US 2019/0147457 A1
(43) Pub. Date: May 16, 2019

(54) PROTECTED DATA TRANSFER COORDINATED WITH SERVICE REQUEST

(71) Applicant: Siemens Healthcare Diagnostics Inc., Tarrytown, NY (US)

(72) Inventors: Steve Magowan, Elkton, MD (US); Catalin Tudose, Yorktown Heights, NY (US)

(73) Assignee: Siemens Healthcare Diagnostics Inc., Tarrytown, NY (US)

(21) Appl. No.: 16/307,195

(22) PCT Filed: Jan. 13, 2017
(86) PCT No.: PCT/US2017/037187

§ 371 Date: Dec. 5, 2018

Related U.S. Application Data
(60) Provisional application No. 62/351,433, filed on Jun. 17, 2016.

(51) Int. Cl. G06Q 30/00; G06F 21/62; H04L 29/08; H04W 64/00

(52) U.S. Cl. CPC G06Q 30/018; H04W 64/003; H04L 67/125; G06F 21/6245

(57) ABSTRACT

A service request interface is provided in association with a laboratory instrument. The interface may be displayed on an interactive display unit, such as a touchscreen monitor associated with the laboratory instrument. When a user initiates a service request by interacting with the interface, relevant system software files containing instrument location, software version, configuration, customer contact, and event codes corresponding to instrument performance and/or status are encrypted and transmitted to a remote ticketing interface for creation of a service ticket and associated ID. Other instrument data files may be transmitted, in association with the service ticket ID, to a remote data services back end. Remote support personnel have access to the data associated with the service ticket ID in the remote ticketing interface and the remote data services back end. Communications between the remote service personnel and the service request or take place via a remote collaboration services back end.

### RELATED APPLICATIONS

This patent application claims priority from U.S. Provisional Patent Application No. 62/351,433, filed Jun. 17, 2016.

### BACKGROUND

Various embodiments relate generally to systems, methods, devices, and computer programs for the protected transfer of data in conjunction with an instrument service request and, more specifically, relate to encrypting Private Health Information (PHI) or other sensitive information, stored in conjunction with an instrument, before conveying the information to a service provider in conjunction with a service request issued by an instrument user.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Normally, when medical lab personnel require assistance with respect to a laboratory instrument, a phone call is placed with or an electronic message is sent to a service representative responsible for the instrument. Typically, the service representative requires the laboratory instrument user to provide certain information relating to the configuration of the instrument, including operating system or other software version, physical location, configuration, customer contact, and error messages or other problems associated with the instrument. This can be time consuming and can lead to missing or erroneous data, either through the fault of the user, the service representative, or both. In addition, certain information stored in conjunction with the laboratory instrument should be available only to authorized local personnel and not to the service representative. For example, sensitive or legally protected data, such as patient-related data known as Protected Health Information (PHI), should not be communicated beyond the local facility and should be accessible only by authorized personnel.

What is needed is a way to convey required data from a laboratory instrument to a service provider in conjunction with a service request in a secured, accurate, and efficient manner, without exposing protected data to unauthorized access.

### BRIEF SUMMARY

The below summary is merely representative and non-limiting.

The above problems are overcome, and other advantages may be realized, by the use of the embodiments.

In a first aspect, an embodiment provides a computer-implemented method for gathering and conveying data characteristic of a laboratory instrument to a remote service provider in conjunction with a service request initiated by a user of the laboratory instrument. Certain protected data stored in conjunction with the laboratory instrument is encrypted to avoid unauthorized access by the remote service provider. The laboratory instrument includes one or more analyzers and sample handling equipment. A computer network associated with laboratory instrument includes one or more computer associated with the one or more analyzers and the sample handling equipment, each computer including a respective processor and memory. The one or more computers are configured to communicate via a communications bus that includes one or more data switches. The computer network further includes a router implementing a firewall, the router enabling selective communication between the laboratory instrument and a laboratory or site network. The laboratory or site network enables selective communication with a remote service provider such as via the Internet. The service provider includes a human or virtual, computer-generated representative and a computer system, along with plural services providing service request processing and data transfer and remote collaboration facilitation. The method includes a user initiating a service request with remote service personnel via a service request user interface displayed within a graphical user interface (GUI) associated with the instrument. In the latter case, the GUI may be presented on a display screen integral with the instrument or on a handheld device such as a tablet computer in wireless communication with the instrument. A processor in the computer network is programmed to respond to the service request by gathering predefined data, receiving data entered by the user, encrypting the data, and conveying the data to the service provider via the router and laboratory or site network. The service provider receives the conveyed data, decrypts the data that was encrypted by the laboratory instrument, and provides derivative data to the representative for use in responding to the requesting user. The remote service assigns a ticket identifier to the request and returns this identifier to the requesting laboratory instrument. Additional data, identified by the ticket identifier, is then assembled and transmitted to the remote service. Meanwhile, the requesting user and service provider communicate such as through a voice channel, text message, email, VOIP, or other mechanism, which may include an exchange of voice or data via the same or different communications network used for conveying the conveyed data. The representative provides input to the user at least in part based upon the conveyed data and the derivative data. The remote service may also provide data to the laboratory instrument, such as software updates.

In another aspect, a service request user interface, or service button, is provided on a user interface for a laboratory or medical instrument, such as an in vitro diagnostics instrument. A non-limiting example of an in vitro diagnostics instrument is a system that is capable of performing immunoassay-based and/or clinical chemistry-based tests on biological samples. The user interface is provided on an interactive display unit, such as a touchscreen monitor that is wirelessly connected, for example, an operator tablet computer, via radio frequency transmission, cellular network, or wireless local area network, or physically attached to the laboratory or medical instrument. When the customer actuates the service button feature by interacting with the user interface, relevant system software files containing instrument location, software version, configuration, customer contact, and event codes corresponding to instrument performance and/or status are automatically transmitted to remote support personnel prior to initial contact with the requesting user through an online, voice, and/or video remote support service.

In a further aspect, an embodiment provides an apparatus (such as a server or plural servers) each having a processor and a memory storing computer program code. The memory and the computer program code are configured to, with the respective processor, cause the apparatus to perform the methods above.

In another aspect, an embodiment provides a computer readable medium tangibly encoded with a computer program executable by a processor to perform any of the methods above.

### BRIEF DESCRIPTION OF THE SEVERAL VIEWS OF THE DRAWINGS

Aspects of the described embodiments are more evident in the following description, when read in conjunction with the attached Figures.

FIG. 1 is a schematic diagram of a system for enabling the transfer of protected data in coordination with a service request;

FIG. 2 is a flowchart of the transfer of protected data in coordination with a service request; and

FIG. 3 is a schematic diagram of customer service provider facilities interfacing to a user instrument within the system of FIG. 1.

### DETAILED DESCRIPTION

Various embodiments allow data to be transferred automatically and safely to a service provider in conjunction with a request for assistance initiated by a user of a laboratory instrument. The data may be used by the service provider to assess the operational status of the laboratory instrument prior to or simultaneously with the user interacting with a representative of the service provider. The service provider may then provide information to the requesting user for remediating an instrument problem, explain options for configuring or operating the instrument, or assist with properly configuring the instrument software or hardware environment. In addition, the service provider may initiate a secure transfer of software program code and/or data to the laboratory instrument through the same communications channel by which the data from the laboratory instrument was received in order to update software being executed by the instrument or to request additional data from the instrument for diagnostic purposes.

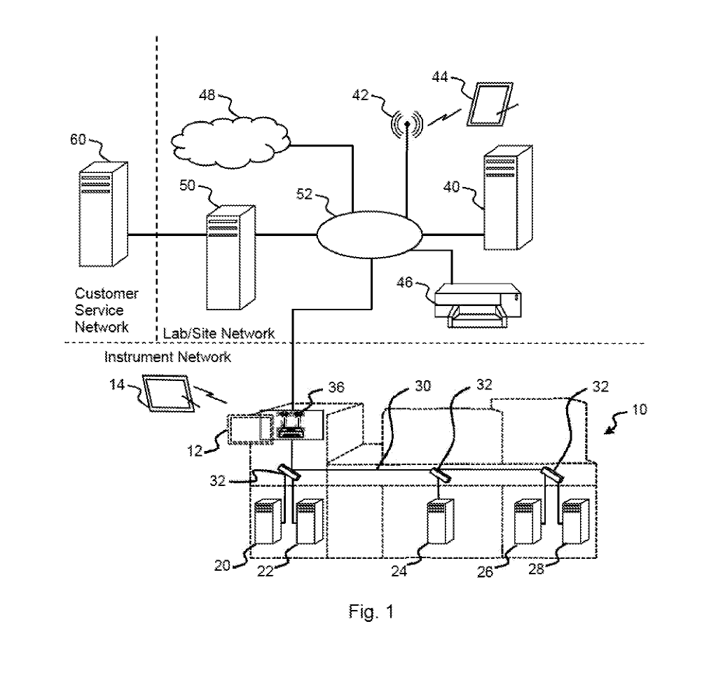

With respect to FIG. 1, a service request interface is provided in association with a laboratory instrument 10. The service request interface can be implemented through a variety of interactive elements. Non-limiting examples include a virtual pushbutton displayed within a graphical user interface (GUI) on a display screen 12 associated with the laboratory instrument or on a display screen of a portable computing device 14 such as a laptop or tablet computer in wireless communication with the laboratory instrument. A specific example of a suitable tablet computer is the Microsoft Surface Pro 4. The wireless communication may be via radio frequency transmission, cellular communications, wireless local area network (WLAN), or Bluetooth-type personal area network (PAN). The display screen may be touch-sensitive or may be provided with one or more soft keys adjacent the screen. The service request interface of the laboratory instrument may include one or more of a speaker and microphone, a telephone handset, a webcam, a keyboard, and a mouse or trackball for enabling interactive communication with personnel of a remote service provider. Certain software functionality implemented within the laboratory instrument may also contribute to the service request interface, including virtual network communications (VNC) or remote desktop capability.

The laboratory instrument may be one of a variety of instruments. Non-limiting examples include a medical laboratory instrument such as an in vitro diagnostics instrument capable of performing immuno-based and/or clinical chemistry-based tests on biological samples. The laboratory instrument is typically disposed within a laboratory setting along with other similar or disparate instruments.

The laboratory instrument may comprise one or more computers. For example, in FIG. 1, the depicted instrument 10 includes a sample handling (SH) computer 20, a process control computer (PCC) 22, a chemistry (CH) analyzer 24, an immunoassay (IM) analyzer computer 26, and an immunoassay device management layer (DML) computer 28. The various computers are interconnected via a communications bus 30 and plural switches 32 serving as an interface to the communications bus, and may be provided by, for example, members of the Intel Core or Texas Instruments SITARA® families of processors. Each computer preferably contains security measures for creating a secure platform, such as employing a secured base image (SBI) and implementing “kiosk mode” operations to limit user privileges. A specific embodiment of such an instrument is known as the ATELLICA® Solution of Siemens Medical Solutions USA, Inc., a multi-component system for in vitro diagnostic testing of clinical specimens. The system is intended for the qualitative and quantitative analysis of various body fluids, using photometric, turbidimetric, chemiluminescent, and integrated ion selective electrode technology for clinical use. However, other laboratory instruments may also be used with the presently disclosed methods and systems.

Communications from the laboratory instrument to other equipment in the laboratory environment and beyond is preferably through a single access point that implements various security measures. For example, as illustrated, the laboratory instrument of FIG. 1 communicates to the lab or site network via a router 36, such as a Cisco Systems model RV130W. Such a router may limit access to select ports, create private network segments and perform address translation to enable external communications, and enable encryption of data transmitted from the laboratory instrument. Non-limiting examples of encryption techniques that may be implemented by the router include internet protocol security (IPSec), HTTP over SSL (HTTPS), an SSL tunnel, or an HTTP tunnel. The router may also enable local, wireless communications with properly configured devices such as tablet computers 14.

The data stored within the laboratory instrument in association with various constituent computers may include patient-specific protected health information (PHI). Such information is typically required to be encrypted in order to avoid inadvertent disclosure to the public or unauthorized users. The laboratory instrument will typically encrypt PHI stored therein. Ideally, the only person or persons having the virtual key required to decrypt the PHI data are those lab personnel having the proper authority; the remote service provider ideally does not have access to the decryption key or to PHI from the laboratory instrument. Exceptions to the latter include copies of instrument internal databases or database backups that may be transmitted to the remote service provider. However, any PHI found within those database copies is encrypted and not viewable by remote service personnel.

The laboratory instrument communicates with a data network associated with the laboratory or physical site in which it is located. Such a network is referred to as a “Lab/Site Network” in FIG. 1. Typical elements of such a network include a laboratory information system (LIS) computer 40 for managing workflow and data tracking within the respective laboratory, a wireless access point (WAP) 42, one or more wireless tablets or other computers 44, standard network peripherals such as printers 46, all interconnected via a router 52. Remote access is enabled through a connection to the Internet 48 and to a variety of Web-based resources, as known in the art.

Also shown in the laboratory or site network of FIG. 1 is a remote service gateway computer 50 for managing and controlling laboratory instruments registered with the remote service provider, here represented by a remote customer service computer 60, though it is understood that there may be a plurality of such remote service computers, each interfacing with one or more remote laboratory or site networks. Communications of data from the laboratory instrument to the remote service is routed through the remote service gateway computer. Such communications from the remote service gateway computer to the remote customer service computer may be via wireless networks, optical fiber networks, wired networks, etc. As noted above, such communications are encrypted, such as through the use of an SSL tunnel.

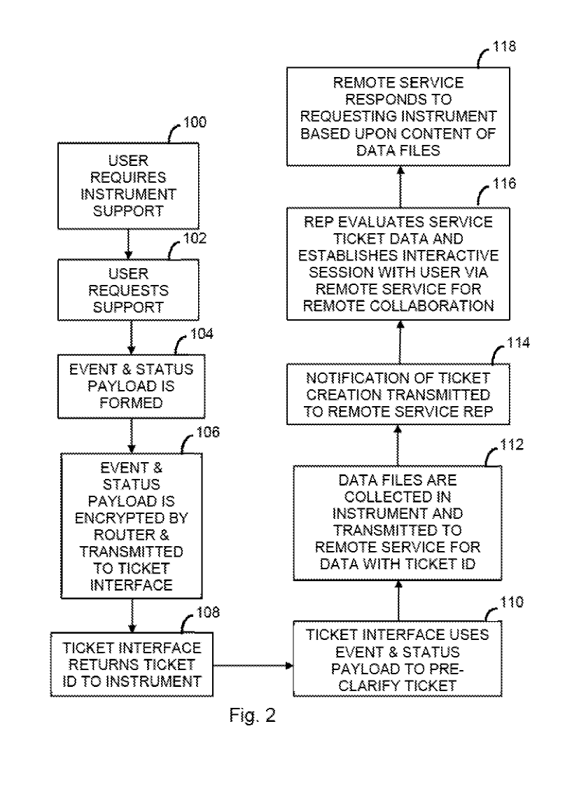

With reference to FIG. 2, a method for an instrument user accessing a remote service according to the present disclosure is illustrated. First, a requesting user, who is typically a lab technician or manager, identifies 100 a condition or problem that requires the assistance of a remote service provider. In response to this identification, the user initiates a support request 102, such as through interaction with a service request user interface (UI), also referred to as a service button UI, provided on a display associated with the laboratory instrument or portable computing device 14 communicating with the instrument. The UI provides multiple functions. First, it enables a user to request an interactive communications session with remote service personnel. This may be via telephone, speaker and microphone associated with the laboratory instrument, text message, email, videoconference, or other means. Second, the service button UI enables a user to review the status of the most recent service request, also referred to as a service ticket, and the status of previously initiated service tickets. Service requests that have been resolved are designated “closed” while those still in process are designated “open.” Third, the service button UI enables a user with flexibility as to the data that will be provided to a remote service in association with the service ticket request. This will be discussed in greater detail, below.

In response to entry of a service request by the user via the service button UI, the process control computer 22 of the laboratory instrument automatically assembles predefined data sets 104 that may be referred to as an event and status payload or event codes. For example, data identifying the laboratory user requesting the service, their contact information, relevant system software data containing instrument serial number, physical location, software version configuration data, and event codes corresponding to the instrument performance and/or status are accumulated by the process control computer. The assembled data also includes a ticket priority entered by the requesting user. In one embodiment, the priority is selected from: urgent; non-urgent; and general inquiry/no problem. In another embodiment, the service button UI provides the requesting user with two free-edit texts fields: a ticket title field, which may be limited to 40 characters, for example; and a problem description field, which may be limited to 2000 characters, for example. Further, a requesting user is asked to provide a four digit passcode that may be used by a remote service provider to engage the requesting user is a collaborative session to address the service request.

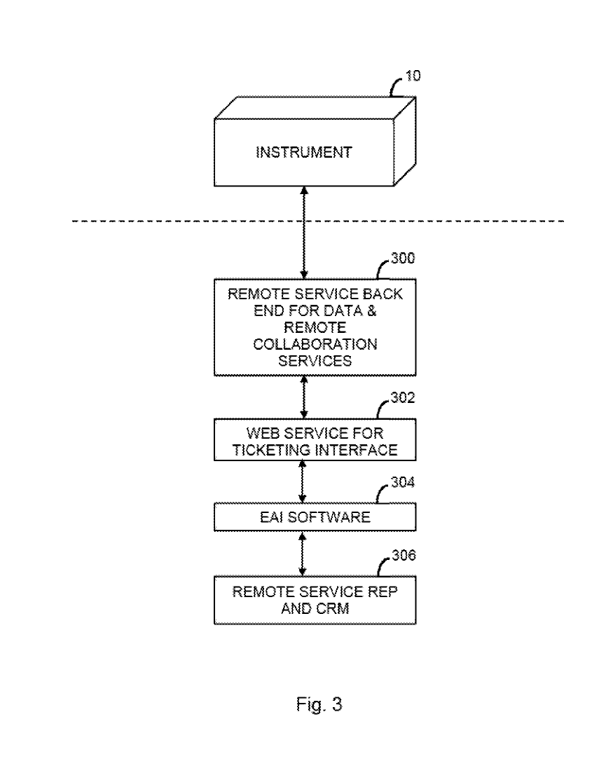

With reference also to FIG. 3, the process control computer 22 of the instrument 10 enters the event and status payload into, for example, a simple object access protocol (SOAP) protocol message and transmits 106 the event and status payload with ticket request to a web service for a ticketing interface 302 via the router 36 and remote service gateway computer 50. All such communications are encrypted and sent via a secure channel such as an SSL tunnel.

At the ticketing interface 302, a new ticket ID is generated and associated with the received, decrypted, and locally stored event and status payload. The ticketing interface returns 108 the ticket ID to the laboratory instrument 10 using the SOAP protocol via the same secure SSL tunnel communications channel. The process control computer 22 enters the new ticket ID into a list of tickets created via the service button UI along with the respective status of the ticket ID. In one embodiment, the process control computer identifies the status of a ticket as “open” unless confirmed “closed” by input from the ticketing interface. At any time, a user may use the service button UI to determine the current status of a previously opened ticket, a process that involves the process control computer querying the ticketing interface for a return message indicative of current status. For each listed ticket, in one embodiment, there is an associated display of creation date and time, most recent status (open versus closed), and the date and time of the most recent status.

The decrypted and locally stored event and status payload data is indexed into a data structure referred to as a service ticket, or more simply, the ticket, associated with the respective ticket ID. Associating the event and status payload data with the respective ticket is referred to as pre-clarifying the ticket 110. The ticket structure subsequently enables remote service personnel to have access to the event and status payload information as fielded in an easily recognizable format.

In addition to the creation of the service ticket, as described in the foregoing, the process control computer 22 identifies a minimum set of predefined data files within the laboratory instrument that are always provided to the remote service whenever a new service ticket is initiated. In one embodiment, the requesting user is also given an opportunity, via the service button UI, to select and send additional data files. The ticket ID returned to the laboratory instrument from the ticketing interface is then used to identify the instrument data files, which are then transmitted 112 to the a remote service back end for data and remote collaboration services 300, via the same secure pathway as the ticket request, event and status payload data, and returned ticket ID. Certain PHI may be included in the with the other instrument data files, such as if a backup of an instrument database is performed. However, the PHI will always be encrypted within the instrument prior to being transmitted to the remote service provider. As noted above, the remote service personnel do not have access to the information necessary to decrypt the PHI.

Once the ticket has been pre-clarified within the ticketing interface 302 and the instrument data files, associated with the same ticket ID as the pre-clarified ticket, have been received and stored with the back end for data services process 300, a notification is sent 114 to remote service personnel 306 responsible for responding to the service request. Such a request, in one embodiment, is transmitted via an enterprise application integration (EAT) software module 304 such as an SAP NETWEAVER® process integration (SAP-PI) module. The service representative now has access to: the service ticket data stored within the ticketing interface 302; the instrument data stored within the back end for data service 300; and a communications channel with the requesting user via the back end for remote collaboration service 300. At this point, the service rep enters into an interactive exchange with the requesting user 116 using the four-digit code defined by the requesting user at the time of initial service request. The rep is able to respond to problems or inquiries while automatically having access to detailed instrument configuration and status information. Thus, when voice, data or other interactive communications are established between the requesting user and the remote service provider, the latter already has the situational context with which to more efficiently and thoroughly assist the requesting user. This avoids the time consuming process of having the requesting user respond to inquiries from the remote service provider for the same information, which would otherwise present the opportunity for transcription errors or miscommunicated information. The remote service provider is then prepared to provide necessary information to the requesting user as soon as a communication link is established.

Depending upon the configuration and operational status of the laboratory instrument, as reflected in the service ticket data and the instrument data, the remote service rep may utilize the same secure data channel to provide data and/or executable files back to the process control computer 22 of the laboratory instrument 10 for the purpose of patching, updating or deleting existing software files, installing new software, or performing other required maintenance to the software or hardware configuration of the laboratory instrument. If all of the issues raised by the requesting user are adequately addressed by the remote service personnel and any optional reconfiguration of instrument software has been carried out by the remote service via the secure channel, the remote service personnel changes the status of the service ticket in the ticketing interface web service 302 to “closed.” The next time service ticket status is updated from the instrument service button UI, the status display within that UI will also change to “closed,” along with the date and time of the revised status.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable media, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. It will be further appreciated by those of ordinary skill in the art that modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A method for initiating customer service via a laboratory instrument, the method comprising:
receiving notification of a user request for service via the laboratory instrument;
in response to receiving the notification, generating, by a processor within the laboratory instrument, service request payload data comprising event codes corresponding to laboratory instrument configuration and status;
encrypting the service request payload data at an interface to the laboratory instrument;
transmitting the service request payload data from the laboratory instrument to a ticketing interface remote service;
decrypting the service request payload data at the ticketing interface remote service; and
receiving communications, by the laboratory instrument processor from the ticketing interface remote service, regarding a ticket identifier associated with the service request payload data.

2. The method of claim 1, wherein the service request payload data further includes at least one of:
a location of the laboratory instrument;
software version information of software running on the laboratory instrument;
data associated with a patient sample under test within the laboratory instrument; and
identity of the user requesting service.

3. The method of claim 1, further comprising accessing software data files associated with the laboratory instrument to determine the service request payload data.

4. The method of claim 1, wherein generating the service request payload data comprises automatically filling out data fields in a service ticket request message corresponding to the service request payload data.

5. The method of claim 1, further comprising generating, by the ticketing interface remote service, the ticket identifier upon transmission of the user request for service and the encrypted service request payload data to the ticketing interface remote service and storing the decrypted service request payload data in association with the ticket identifier.

6. The method of claim 1, further comprising:
generating, by the laboratory instrument processor, instrument data files associated with the ticket identifier; and
transmitting the instrument data files to a data remote service for storage, the instrument data files identifiable within the data remote service by the respective ticket identifier.

7. The method of claim 6, wherein the instrument data files comprise at least one of: log files, event characterizing data, display screen capture information, database backup files, diagnostic data, and laboratory instrument maintenance records.

8. The method of claim 6, wherein the step of generating instrument data files further comprises enabling a user requesting service to select laboratory instrument data files to be included in the instrument data files to be transmitted to the data remote service.

9. The method of claim 6, further comprising:
transmitting the ticket identifier to a service representative; and
initiating communications between the service representative and the user requesting service using the ticket identifier and a collaboration remote service.

10. The method of claim 9, wherein the step of initiating communications further comprises accessing, by the service representative, the service request payload data associated with the ticket identifier in the ticketing interface remote service and the instrument data files associated with the ticket identifier in the data remote service.

11. The method of claim 6, further comprising:
transmitting the ticket identifier to a remote representative;
assembling a service reply message, by the remote representative, based upon the instrument data files associated with the ticket identifier in the data remote service; and
transmitting the service reply message to the laboratory instrument processor.

12. The method of claim 11, wherein the service reply message comprises instructions to modify software executable by the laboratory instrument processor.

13. A laboratory instrument comprising:
a service request user interface (UI);
at least one processor and associated memory including computer program code, wherein the memory and the computer program code are configured, with the at least one processor, to respond to initiation of a service request via the service request UI by generating service request payload data comprising event codes corresponding to the configuration and status of the laboratory instrument; and
a firewall device, in communications with the at least one processor, the memory, and an external communications network, for selectively encrypting at least a portion of the service request payload data including the event codes and for transmitting the service request payload data to a ticketing interface remote service.

14. The laboratory instrument of claim 13, wherein the service request payload data further includes at least one of:
a location of the laboratory instrument;
software version information of software running on the laboratory instrument;
data associated with a patient sample under test within the laboratory instrument; and
laboratory instrument user identity.

15. The laboratory instrument of claim 13, wherein the memory and the computer program code are further configured, with the at least one processor, to receive from the ticketing interface remote service a service ticket identifier associated with the service request payload data transmitted to the ticketing interface remote service.

16. The laboratory instrument of claim 13, wherein the memory and the computer program code are further configured, with the at least one processor, to respond to initiation of the service request by generating instrument data comprising at least one of: log files, event characterizing data, display screen capture information, database backup files, diagnostic data, and laboratory instrument maintenance records, and
wherein the firewall device is further for selectively encrypting at least a portion of the instrument data and for transmitting the instrument data to a data remote service.

17. The laboratory instrument of claim 13, further comprising a communications interface for enabling an instrument user, having initiated a service request via the service request UI, to communicate with a remote service representative, the remote service representative having electronic access at least to the service request payload data including the event codes at the ticketing interface remote service.

18. A method of securely transmitting diagnostic information characteristic of a laboratory instrument operational status to a remote service in conjunction with a user request for an interactive service session with the remote service, comprising:
receiving notification of the user request for the interactive service session at a processor of the laboratory instrument;
collating, by the processor, operational status data at the time of receipt of the user request notification into a service request payload;
assembling a service ticket request having the service request payload;
encrypting the service ticket request and associated service request payload;
transmitting the service ticket request and associated service request payload to a ticketing interface remote service;
receiving, at the processor from the ticketing interface remote service, a ticket ID associated with the service ticket request and associated service request payload;
receiving, at the remote service, the ticket ID;
analyzing the service request payload associated with the ticket ID at the ticketing interface remote service; and
initiating the interactive service session with the remote service with regard to the service request.

19. The method of claim 18, wherein collating operational status data comprises collating at least one of:
a location of the laboratory instrument;
software version information of software being executed by the processor;
data associated with a patient sample under test within the laboratory instrument; and
the identity of laboratory instrument user requesting the interactive session.

20. The method of claim 18, further comprising:
decrypting the service ticket request and associated service request payload at the ticketing interface remote service;
extracting the collated operational status data from the decrypted service request payload;
presenting at least a portion of the extracted status data to a customer service representative of the remote service; and
initiating the interactive service session with the laboratory instrument user requesting the interactive session and the customer service representative of the remote service.

21. The method of claim 18, further comprising:
collating, by the processor, instrument data comprising at least one of: log files, event characterizing data, display screen capture information, database backup files, diagnostic data, and laboratory instrument maintenance records;
encrypting the collated instrument data;
transmitting the encrypted instrument data to a data remote service with the ticket ID;
decrypting, extracting, and storing at least a portion of the instrument data in association with the data remote service;
presenting at least a portion of the stored instrument data to a customer service representative of the remote service; and
initiating the interactive session with the laboratory instrument user requesting the interactive session and the customer service representative of the remote service.
